(19) United States
(12) Patent Application Publication
(10) Pub. No.: US 2024/0084633 A1
(43) Pub. Date: Mar. 14, 2024

(54) Window Regulator for a Side Window of a Motor Vehicle

(71) Applicant: Bayerische Motoren Werke Aktiengesellschaft, Muenchen (DE)

(72) Inventor: Stefan LEINWEBER, Herrsching am Ammersee (DE)

(21) Appl. No.: 18/274,246

(22) PCT Filed: Mar. 9, 2022
(86) PCT No.: PCT/EP2022/055971

§ 371 Date: Jul. 26, 2023

(30) Foreign Application Priority Data
Apr. 6, 2021 (DE) 10 2021 108 529.2
Jun. 25, 2021 (DE) 10 2021 116 505.9

(51) Int. Cl. E05D 15/16; B60J 1/17; E05F 11/38; E05F 15/697

(52) U.S. Cl. CPC E05D 15/165; B60J 1/17; E05F 11/385; E05F 15/697; E05Y 2201/64; E05Y 2201/684; E05Y 2600/12; E05Y 2900/55

(57) ABSTRACT

A window regulator for a side window of a motor vehicle, includes a slide guide rail on which a rail slide is slidably arranged. The side window is attached to a window holder arranged on the rail slide and the rail slide can be displaced largely in a Z-direction into an upper position and into a lower position. The slide guide rail can be fixed in position at an upper attachment point and a lower attachment point on a body part. The window holder and the upper attachment point and the lower attachment point are on a straight connecting line. The configuration of the window regulator ensures precise closing of the side window, in particular for frameless side windows, of a motor vehicle, even when the motor vehicle is travelling at very high speeds.

### BACKGROUND AND SUMMARY

The invention relates to a window regulator for a side window of a motor vehicle and to a motor vehicle having such a window regulator.

As regards the technical field, reference is made to the European patent application EP 1 526 242 A2, for example. This published application discloses a method for controlling the movement of a side window of a side door of a motor vehicle, which side window is movable by means of a window regulator actuated by external force. In the proposed method, depending on a movement of the side door, the side window is automatically moved by the window regulator into a predetermined intermediate position, which deviates from a fully closed or lowered position of the side window. In order to avoid rattling noises from the side window, it is provided that, starting from the fully lowered position of the side window, the side window is raised, at least when the side door is closed, into the intermediate position in which the side window is moved with its upper edge at least partially into a sealing gap lying on the upholstery of the side door.

Another window regulator for a motor vehicle door is known, for example, from the German patent application DE 102 04 610 A1. A window regulator, in particular a cable or tube window regulator, is disclosed for a frameless guided motor vehicle window pane, with at least one guide rail extending along the adjustment path of the window pane, with adjustment means for adjusting the inclination of the at least one guide rail with respect to a plane containing the longitudinal axis of the motor vehicle, and with locking means for locking the adjusted position of the guide rail with respect to a body part or to a part associated therewith. The adjusting and locking means are provided in the lower region of the guide rail as screw connections, which adjusting means have an adjusting screw pre-assembled on the lower end of the guide rail and extending approximately transversely with respect to the longitudinal axis of the motor vehicle, which adjusting screw, by means of a form-fitting region arranged at one of its ends, is rotatably mounted in a corresponding region of the body part or the like.

A window device for a motor vehicle is also known from the German patent specification DE 10 2015 000 562 B3. The latter claims a window device for a motor vehicle, having at least one window that is movable relative to a guide channel of the window device, and having at least one guide device for supporting the movable window in the guide channel. The at least one guide device is arranged in a gap region between an end wall of the guide channel and an opposite side edge of the movable window. The at least one guide device is elastically deformable at least in some regions. According to the invention, the guide device comprises a holding element which is materially connected to the window.

Reference is also made to the German utility model specification DE 20 2004 018 460 U1. This utility model specification discloses a driver for a window regulator device, which has a base body with a flexible holding leg and a recess that is intended to accommodate a guide rail and provides a sliding device for this, and with a fitting body, the fitting body being movable relative to the base body between a plurality of positions and being able to be fixed in each of these positions, the fitting body being held on the flexible holding leg.

Furthermore, the German patent application DE 10 2011 110 168 A1, from which the present invention derives, discloses an arrangement for attaching a window pane to a window regulator of a vehicle, with a specially designed window holder which in turn has a holding portion for attaching the window holder to a window pane and a connecting portion for attaching the window holder and window pane to a clamping jaw element of a lowering and lifting mechanism of a window regulator. The holding portion of the window holder is formed by a U-shaped profile which is open at the top when viewed in cross section and which has a profile bottom and two profile flanges laterally enclosing the window pane. A connecting portion of the window holder, in the form of a fastening web, adjoins the bottom profile at the bottom. Advantageously, the profile flanges each have a window-like cutout that extends at least into the bottom of the profile. The clamping jaws of the clamping jaw element can thereby be inserted at least in sections into said cutout.

On account of insufficient prestressing of a side window of a motor vehicle in relation to a seal on the roof frame and/or on the B-pillar, it can happen that the upper region of the side window does not bear properly on the seal of the roof frame. The subsequent mechanical adjustment of a window regulator system is often not possible or is only possible with great difficulty. This often applies to the front doors of the motor vehicle. With an unfavorable geometric design of the side window in the A-pillar, and also the B-pillar, the necessary prestressing in the Y direction (transverse to a vehicle longitudinal axis) is sometimes not achieved. This can result in a lack of leaktightness to air and water. The problem mentioned above is evident particularly in window regulator systems for convertible vehicles or coupes with frameless side windows. This applies in particular to the leaktightness in the region of the B-pillar and the adjoining roof frame.

The object of the present invention is to make available a measure which permits precise closing of the side window of a motor vehicle, in all possible operating conditions, especially when the motor vehicle is being driven at very high speed.

This object is achieved by the features of the independent claim, in which the window holder and the upper attachment point and the lower attachment point of the slide guide rail for the rail slide on which the window holder is arranged lie on a straight connecting line.

By virtue of the configuration according to the invention, the side window of the motor vehicle is pressed firmly onto the circumferential sealing region, particularly in the region of the B-pillar and the adjoining roof frame, even at high speeds, for example over 210 km/h. This therefore reliably prevents lifting of the side window at top speeds and ingress of ambient air or water into the passenger compartment. The window regulator according to the invention can advantageously be used both for frameless side windows and for side windows with frames in so-called framed doors.

The window holder usually has a diameter of between 20 mm and 150 mm. Instead of a round window holder, the latter can also be square, rectangular or designed with some other external geometry.

Advantageous developments of the invention are described in the dependent claims.

The configuration according to an aspect of the invention, in which the window attachment point and the upper attachment point and the lower attachment point of the slide guide rail lie on a straight connecting line, further increases the leaktightness of the window by virtue of a still more precise arrangement of the window regulator components. With this configuration, the lever on the flexible axis is further reduced, while at the same time the lever on the rigid axis is increased. A rigid axis is understood to mean the extension of the slide guide rail. The flexible axis is in this case aligned at right angles to the slide guide rail, approximately in the X direction. The window attachment point usually has a diameter of between 5 mm and 15 mm.

With the configuration according to another aspect of the invention, in which a window guide rail aligned parallel to the slide guide rail is arranged on the slide guide rail, the system rigidity increases again considerably and optimizes the window guide rail in the direction of the vehicle longitudinal axis X.

In a particularly advantageous embodiment, the window guide rail encloses an edge region of the side window in a U shape. This configuration also optimally guides the side window in the Y direction, transverse to the vehicle longitudinal axis X. This measure also results in the window guide rail, and thus also the slide guide rail, being arranged as close as possible in the X direction to the edge region of the side window.

In a further development, an elastic element is arranged in the U-shaped region of the window guide rail, largely in the Z direction, and bears linearly on at least one side of the side window. The elastic element can be a sealing element, for example made of a soft plastic, e.g. a rubber or a silicone material. With the aid of this elastic enclosure of the side window, the side window is guided even better in the Y direction or softly mounted, and rattling of the side window, for example when closing a door, is reliably avoided.

Advantageously, the elastic element extends over the entire height of the window guide rail. It is also conceivable for the elastic element to extend only in sections over the height of the window guide rail. With this configuration, the side window is mounted and guided in the best possible way in every height position.

In a particularly preferred embodiment, in which a clear width of the side window is geodetically limited above the window regulator, the window guide rail extends as far as the limit of the clear width. This limit can be a channel covering, for example. This configuration advantageously gives the side window the maximum possible guidance along the vertical axis Z of the vehicle.

The configuration in which the window guide rail has a further attachment point for position fixing on the body part leads to the best possible reinforcement of the window regulator system.

With the configuration in which a distance between the slide guide rail and the body part in the Y direction is adjustable at the upper attachment point and/or the lower attachment point, it is possible to subsequently set or adjust the window regulator system or the side window.

In a first embodiment, the slide guide rail and the window guide rail are produced in one piece and from the same material. This configuration permits production with little tolerance.

In a second embodiment, the slide guide rail and the window guide rail are two separate components which are connectable to each other. This could lead to simplified and more cost-effective production but would incur assembly costs for the components.

In a particularly preferred embodiment, the body part is a side door of the motor vehicle. In another embodiment, the body part can also be a side part of the body, for example if a rear side window of the motor vehicle is also intended to be retractable.

With the configuration in which the window regulator is an electrically operable window regulator, a contemporary embodiment is provided.

In addition, the invention also claims a motor vehicle having a window regulator according to the invention as per one of the aforementioned claims.

The following may be stated in summary. By arranging the window holder and the upper attachment point and the lower attachment point of the slide guide rail on a straight connecting line, maximum rigidity of the window regulator system is achieved. In addition, the integration of the slide guide rail and the window guide rail in a single component (in one piece or joined) leads to a shortening of the path in the vehicle longitudinal direction X for possible bending of the system, for example at high speed and window closing. The forces are transferred directly into the door shell or body shell without bending stress.

The structural arrangement, within the door, of slide guide rail and window guide rail is such that the load input into the side window and the load transferred away from the side window are supported by a flexible lever that is as short as possible. As a result, the distance in the X direction between the sealing system (B-pillar cover and edge protection or door seal) and the integral rail (consisting of the slide guide rail and mainly the window guide rail) is minimal.

In addition, the enclosure of the side window at the moveable edge creates a further load path that prevents the side window from deforming. The request to close the window at a speed of, for example, 210 km/h is thus made possible. Furthermore, a stabilization of the side window during door closure is made possible for low-noise, high-quality closing behavior of the side doors of the motor vehicle.

The invention is explained in more detail below with reference to seven figures.

### BRIEF DESCRIPTION OF THE DRAWINGS

FIG. 1 shows a plan view of a window regulator according to an embodiment of the invention.

FIG. 2 shows a plan view of the window regulator with a distribution of the resulting forces and force components.

FIG. 3 shows a plan view of the window regulator with four sections indicated.

FIG. 3a shows a section A-A from FIG. 3.

FIG. 3b shows a section B-B from FIG. 3.

FIG. 3c shows a section C-C from FIG. 3.

FIG. 3d shows a section D-D from FIG. 3.

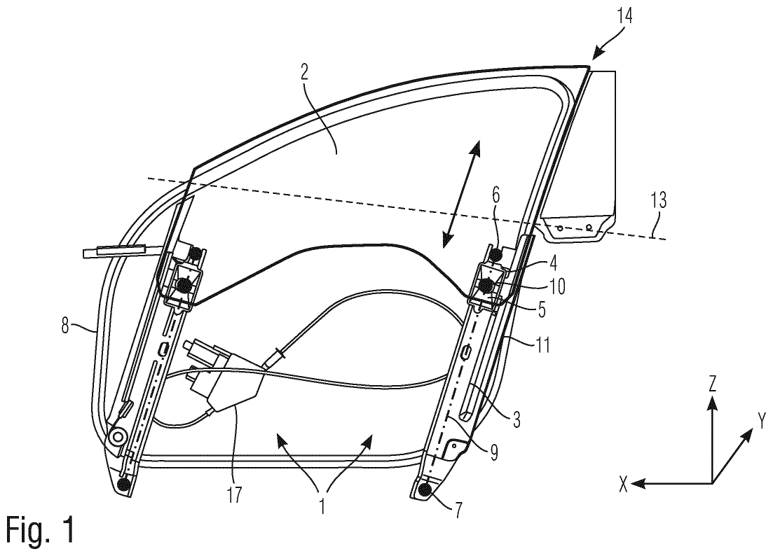

In the following, the same reference numbers apply to the same components in FIGS. 1 to 3d.

### DETAILED DESCRIPTION OF THE DRAWINGS

FIG. 1 shows a plan view of a window regulator 1 for a side window 2 of a motor vehicle (the latter is not shown in detail). The motor vehicle is preferably a convertible or a coupe with frameless side windows 2. A coordinate system which describes the axes is shown at the bottom right of FIG. 1. An X axis corresponds to a vehicle longitudinal axis, a Y axis corresponds to a vehicle transverse axis, and a Z axis corresponds to a vehicle vertical axis. The X axis at the same time represents the main direction of travel of the motor vehicle.

FIG. 1 shows the window regulator 1 consisting of two slide guide rails 3, one slide guide rail being arranged to the front in the direction of travel and one slide guide rail 3 being arranged to the rear in the direction of travel; only the components of the window regulator 1 that are arranged to the rear in the direction of travel are numbered.

In a further exemplary embodiment, it is also possible for just a single slide guide rail 3 to be provided for a narrow side window 2, for example in the rear region of the motor vehicle. In the present exemplary embodiment, the slide guide rails 3 and other components are largely mirror-symmetrical and identical in design. Furthermore, the present window regulator 1 has an electric drive 17, with which a rail slide 4 is slidable on the slide guide rail 3, largely in a Z direction, into an upper position and a lower position. Upper position means the side window 2 is closed, while lower position means the side window 2 is open. A direction of displacement of the side window 2 is indicated symbolically with a double arrow. Since a body of a motor vehicle is not aligned strictly according to coordinates, but primarily according to design specifications, the expression “largely in a Z direction” means that the side window 2 is movable up and down.

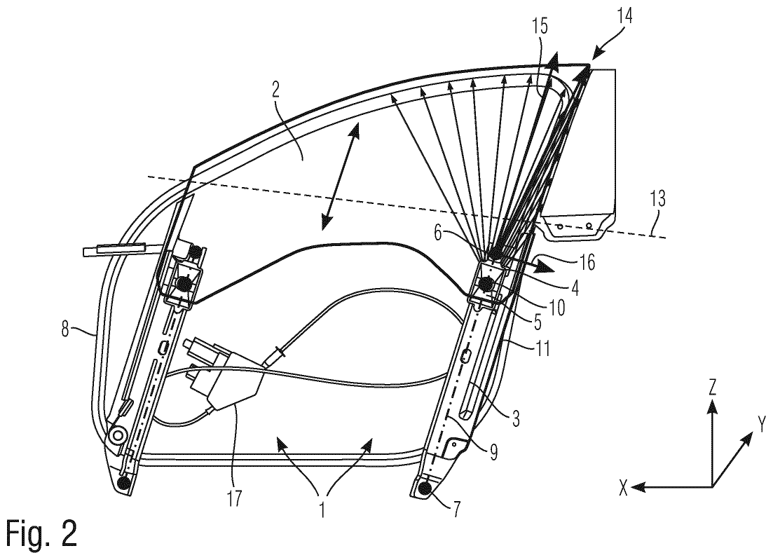

The side window 2 is attached to two window holders 5 arranged on the rail slides 4. In order to ensure that the side window 2 is cleanly guided, the slide guide rails 3 have an upper attachment point 6 and a lower attachment point 7, at which the slide guide rail 3 is able to be fixed in position on a body part 8 (represented by a seal in FIGS. 1 and 2). In the present exemplary embodiment, the body part 8 is a side door of the motor vehicle. In a further exemplary embodiment, for example in the case of a coupe, it can also be a side wall of the body of the motor vehicle, if the rear side window is likewise intended to be openable or closable.

The window holder 5 and the upper attachment point 6 and the lower attachment point 7 of the slide guide rail 3 lie on a straight connecting line 9, shown by a dot-and-dash line. By virtue of the design of the window regulator 1, a lever on the flexible axis 16 (see FIG. 2) is minimized, while a lever on the rigid axis 15 (see FIG. 2) is maximized. When the side window 2 is closed, this ensures that the side window 2 presses firmly onto the substantially surrounding seal, in particular in a sealing region of a B-pillar 14 and an adjoining roof region of the motor vehicle.

The window regulator 1 can advantageously be used both for frameless side windows 2 and for side windows 2 with frames in so-called frame doors.

The window holder 5 usually has a diameter of between 20 mm and 150 mm. Instead of a round window holder 5, the latter can also be square, rectangular or designed with some other external geometry.

Usually, as in the present exemplary embodiment, the window holder 5 has a window attachment point 10 at which the side window 2 is attached, for example screwed on. In a development of the invention, the window attachment point 10 and the upper attachment point 6 and the lower attachment point 7 lie on a straight connecting line 9. The window attachment point 10 usually has a diameter of between 5 mm and 15 mm. As a result, the tolerances are further reduced, and the effect according to the invention is increased.

It can also be seen from FIG. 1 that a window guide rail 11 aligned parallel to the slide guide rail 3 is arranged on the slide guide rail 3. Here, the window guide rail 11 encloses an edge region (in the X direction and Y direction) of the side window 2 in a U shape. This measure ensures that the side window 2 is guided exactly in both the X direction and the Y direction, and rattling noises are avoided. This measure also results in the window guide rail 11, and thus also the slide guide rail 3, being arranged as close as possible to the edge region of the side window 2 in the X direction.

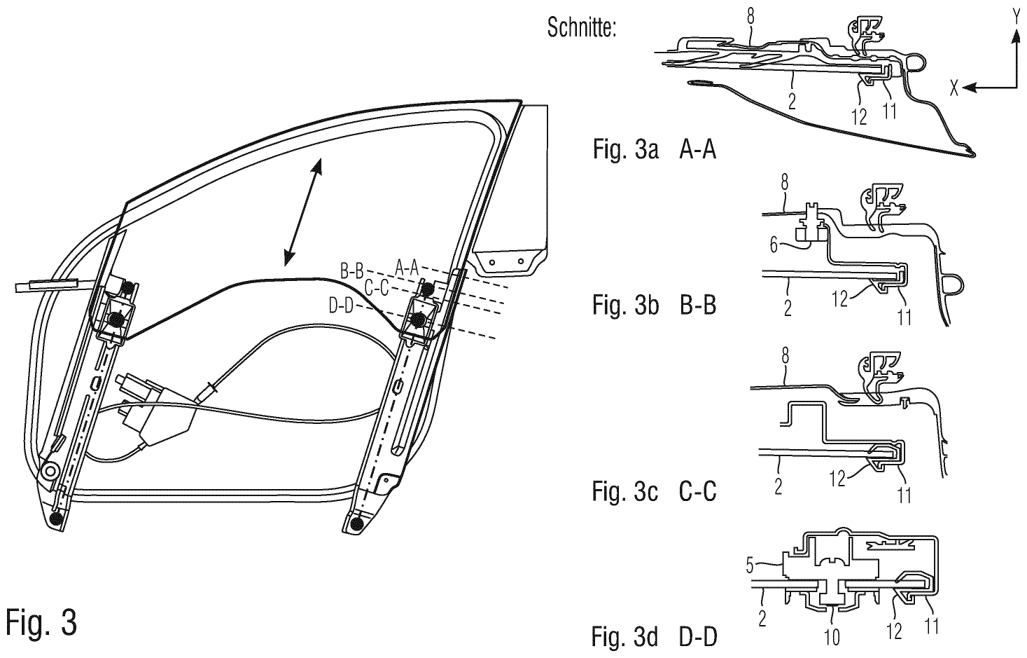

In addition, it has been shown to be particularly advantageous if an elastic element 12 is arranged in the U-shaped region of the window guide rail 11, largely in the Z direction, and bears linearly on at least one side of the side window 2. This can be, for example, a rubber seal or a silicone seal. This elastic element 12 is shown in FIGS. 3a to 3d.

The elastic element 12 particularly preferably extends over an entire height of the window guide rail 11, which leads to excellent guidance of the side window 2 and prevents the side window 2 from rattling, for example when closing a vehicle door or when driving on a bumpy surface.

A clear width of the side window 2 is usually limited geodetically toward the bottom, for example by a channel covering, which is shown schematically in FIG. 1 with a dashed line 13. The window guide rail 11 preferably extends as far as this limit 13 of the clear width. This results in the maximum possible guidance of the side window 2 when opening or closing it.

In a development of the window regulator 1 according to the invention, the window guide rail 11 has a further attachment point for position fixing on the body part 8, as a further stiffening measure.

In a particularly preferred embodiment, a distance between the slide guide rail 3 and the body part 8 is adjustable at the upper attachment point 6 and/or at the lower attachment point 7 in the Y direction. In this case, a subsequent adjustment of the window regulator 1 or of the side window 2 is also possible, and therefore, even if the tolerances of the individual components with respect to one another are very poor, the side window 2 can be readjusted for the best possible sealing.

In a first configuration, as in the present exemplary embodiment, the slide guide rail 3 and the window guide rail 11 are in one piece and of the same material, such that the tolerances in relation to the body part 8 are minimal.

In a further exemplary embodiment, the slide guide rail 3 and the window guide rail 11 can also be two separate components which are connectable to each other, as a result of which, for example, production costs could be reduced, although this would entail greater assembly effort.

In a preferred exemplary embodiment, as in the present exemplary embodiment, the body part 8 is a side door of the motor vehicle. In a further exemplary embodiment, it can also be the side wall of the body for a rear side window 2. This is suitable, for example, for a coupe with rear side windows 2 that can be closed and opened.

The window regulator 1, as in the present exemplary embodiment, is preferably an electrically operated window regulator 1 and is therefore contemporary.

FIG. 2 again shows the plan view of the window regulator 1 according to the invention from FIG. 1. FIG. 2 now indicates the resulting forces and force components after the side window 2 has been closed. The configuration according to the invention results in a lever 15 about a rigid axis and a lever 16 about a flexible axis. The resulting forces and moments are indicated with arrows starting from the window holder 5. As can be seen, there are forces exclusively on the sealing region of the side window 2, which leads to an optimal closing behavior of the side window 2. The tightness of the side window 2 is guaranteed at a maximum speed of the motor vehicle of over 210 km/h or, for example, in a car wash. As can be seen from FIG. 2, the forces on the side window 2 are distributed in particular over the important and critical closing region in the area of the sealing of the B-pillar 14 of the motor vehicle.

FIG. 3 again shows a plan view of the window regulator 1 according to the invention from FIGS. 1 and 2, but without numbering, so as to provide a better overview. FIG. 3 indicates four sections through the slide guide rail 3 and the window guide rail 11. A section A-A is located geodetically above the upper attachment point 6. A section B-B is drawn through the upper attachment point 6. A section C-C is located between the upper attachment point 6 and the rail slide 4. A fourth section D-D extends through the window attachment point 10.

FIG. 3a shows the section A-A from FIG. 3. FIG. 3a shows the side window 2, which is guided in an edge region by the window guide rail 11 and elastic element 12 in the X direction. The body part is again numbered 8. Further parts that are not essential to the invention are unnumbered. A coordinate system at the top right, valid for FIGS. 3a to 3d, shows the vehicle longitudinal axis X and the vehicle transverse axis Y.

FIG. 3b shows the section B-B from FIG. 3. As can be seen from FIG. 3b, the window guide rail 11 now encloses the side window 2 in a U shape in the X and Y directions, with the elastic element 12 being in linear contact on one side with the side window 2. In the present exemplary embodiment, the upper attachment point 6 of the slide guide rail 3 is a clip connection, for example.

FIG. 3c shows the section C-C from FIG. 3. As can be seen from FIG. 3c, not only the window guide rail 11 but also the elastic element 12 now encloses the window in a U-shape and bears on both sides with a linear contact on the side window 2, as a result of which an ideal elastic mounting of the side window 2 in the Y direction is guaranteed.

FIG. 3d shows the section D-D from FIG. 3. The window holder 5 has a window attachment point 10 to which the side window 2 is attached. In the present exemplary embodiment, the window attachment point 10 is a screw connection, for example, but adhesive connections are also possible. Also in FIG. 3d, the window guide rail 11 encloses the side window 2 in a U shape. In addition, the side window 2 is also supported on two sides by an elastic element 12 in this section.

### LIST OF REFERENCE SIGNS

1 window regulator
2 side window
3 slide guide rail
4 rail slide
5 window holder
6 upper attachment point
7 lower attachment point
8 body part
9 connecting line
10 window attachment point
11 window guide rail
12 elastic element
13 limit
14 seal of B-pillar
15 lever, rigid axis
16 lever, flexible axis
7 electric drive
X longitudinal axis of vehicle
Y transverse axis of vehicle
Z vertical axis of vehicle

1.-14. (canceled)

15. A window regulator for a side window of a motor vehicle, comprising:
a slide guide rail on which a rail slide is slidably arranged, wherein the side window is attachable to a window holder arranged on the rail slide, and the rail slide is displaceable largely in a Z direction into an upper position and into a lower position, wherein
the slide guide rail is able to be fixed in position at an upper attachment point and a lower attachment point on a body part, and
the window holder and the upper attachment point and the lower attachment point lie on a straight connecting line.

16. The window regulator according to claim 15, wherein
the window holder has a window attachment point, and
the window attachment point and the upper attachment point and the lower attachment point lie on a straight connecting line.

17. The window regulator according to claim 15, further comprising:
a window guide rail aligned parallel to the slide guide rail, the window guide rail being arranged on the slide guide rail.

18. The window regulator according to claim 18, wherein
the window guide rail encloses an edge region of the side window in a U shape.

19. The window regulator according to claim 18, further comprising:
an elastic element arranged in the U-shape region of the window guide rail, largely in the Z direction, bears linearly on at least one side of the side window.

20. The window regulator according to claim 19, wherein
the elastic element extends over an entire height of the window guide rail.

21. The window regulator according to claim 17, wherein
a clear width of the side window is geodetically limited above the window regulator, and
the window guide rail extends as far as a limit of the clear width.

22. The window regulator according to claim 17, wherein
the window guide rail has a further attachment point for position fixing on the body part.

23. The window regulator according to claim 15, wherein
a distance between the slide guide rail and the body part is adjustable at the upper attachment point and/or the lower attachment point.

24. The window regulator according to claim 17, wherein
the slide guide rail and the window guide rail are in one piece and of a same material.

25. The window regulator according to claim 17, wherein
the slide guide rail and the window guide rail are two separate components which are connectable to each other.

26. The window regulator according to claim 15, wherein
the body part is a side door of the motor vehicle.

27. The window regulator according to claim 15, wherein
the window regulator is an electrically operable window regulator.

28. A motor vehicle comprising a window regulator according to claim 15.
